(19) United States
(12) Patent Application Publication
(10) Pub. No.: US 2007/0006762 A1
(43) Pub. Date: Jan. 11, 2007

(54) Method and a device for controlling the quality of print

(75) Inventors: Klaus Jernstrom, Lappeenranta (FI); Teuvo Leppanen, Taavetti (FI); Jarkko Purontaus, Lappeenranta (FI)

Correspondence Address: VENABLE LLP, P.O. BOX 34385, WASHINGTON, DC, 20043-9998, US

(73) Assignee: UPM-Kymmene Corporation, Helsinki (FI)

(21) Appl. No.: 11/476,174

(22) Filed: Jun. 28, 2006

(30) Foreign Application Priority Data
Jul. 1, 2005 (FI) 20055382

(51) Int. Cl. B41F 33/00

(52) U.S. Cl. 101/484

(57) ABSTRACT

A method and a device for monitoring the quality of print formed in a printing process, in which a web running continuously in a printing machine is measured substantially continuously by at least one measuring means. In addition to the product to be printed, at least one image pattern, which is printed with at least one printing ink and surrounded by unprinted paper, has been printed on the web. Both the image pattern and the unprinted paper are measured by the same measuring means, or at least one runnability or condition monitoring parameter of the printing machine is measured. The obtained measurement results are compared, and at least one factor affecting the quality of the print on the basis of the comparison is determined.

### FIELD OF THE INVENTION

The invention relates to a method for controlling the quality of print formed in a printing process and a device for implementing the aforementioned method.

### BACKGROUND OF THE INVENTION

The printing of paper, particularly web-like paper, is a continuous process, during which it is important to monitor the print produced by the printing machine in order to meet the quality requirements set for the final product. The main steps in the process of printing web-like paper are the unwinding, printing, drying, cooling, and folding of paper. Furthermore, the process includes, for example, process elements relating to the guiding of the paper web and the controlling of the suitable tension of the web. In the printing step of paper, the paper web to be printed is guided through a nip, i.e. the printing nip, formed by two rotating rolls extending transversely across the width of the web. By the effect of the pressure prevailing in the nip, ink on the surface of at least one of the rolls is transferred to the paper running through the nip.

In offset printing, the printing step comprises one or more printing units in which the printing ink is supplied to a printing plate from an ink duct by means of a distributor roll, transfer rolls and bobbin rolls. The shape and the tone level of the desired pattern or text are taken into account when supplying the ink. After that, moistening water is supplied onto the printing plate to moisten and emulsify the printing ink. The moistening water is supplied from a water fountain by means of the distributor roll, the transfer rolls and the bobbin rolls. The emulsified printing ink is transferred from the printing plate onto a printing roll with a rubber surface, which is one of the two rolls forming the printing nip. In web offset printing, both of the rolls forming the printing nip are printing rolls, wherein printing ink has been supplied onto both of them and the printing takes place on both sides of the paper simultaneously.

If the pattern to be printed is coloured, the printing machine comprises a separate printing unit of the above-described kind for each printing ink. For example, in CMY printing, there are a total of four printing units, one for each colour, which are: black, cyan, magenta, and yellow. By printing these colours on top of each other in correct ratios, the desired colour tone is achieved in the final product.

As can be seen from the above description, solely the printing step comprises a number of process steps and elements whose condition and function affect the print on the paper. These include, for example, the printing plates, the rolls involved in the transfer of ink and water, and the printing rolls. Furthermore, variations and disturbances in the ink feeding devices and the water supplying device affect the print by causing variations in the tone value of the printing ink. Changes in the print are also produced by variations caused by the devices involved in the mechanical adjustments of the printing machine, such as the adjustment of the nip pressure of the printing nip and the web tension. Furthermore, the print is affected by material variations of the parts used in the printing process, such as the printing plates and the printing rubbers.

Furthermore, the quality of the paper to be printed affects the print. In papermaking, the quality of the paper formed is normally controlled by continuous measurements. In the finished paper supplied to the printing house, however, quality deviations may occur either in the length or machine direction (MD-direction) of the web or in the width or cross direction (CD-direction), affecting the print and/or runnability of the printing machine. Thus, the printability of the paper cannot be predicted solely on the basis of the measured properties of the paper. Furthermore, the interactions between the paper and the printing process cause changes in the print.

The measurement and the monitoring of the print during the printing process are known. Publication WO 87/06190 teaches the measurement of the tone value of the print and the registering of the different colours by means of a densitometer. On the paper to be measured, test spots having a small diameter are printed on an area to be cut off the final product, the measuring being synchronized on these. A disadvantage of this method is that the density measurement does not provide information on how the print is affected by variations in the quality of the printing paper.

The density has also been measured by means of a traversing measuring sensor, i.e. one that moves continuously back and forth across the width of the web. A disadvantage of this method is that it is difficult to find out variations of the printing process in the machine direction, because the measuring point changes and possible variations in color and in the quantity of the moisturing water caused by the printing motif will affect the measurement results obtained.

Publication U.S. Pat. No. 6,050,192 discloses a method for adjusting the printing process. In the method, an imaging measuring device is installed in the printing machine to measure the printed area and the paper to be printed separately and alternately. No separate test pattern will be needed. By means of the measurement results obtained from the printed area, it is possible to monitor the quality of the printed area as well as the control of the ink parameters and the moistening of the ink. The aim of the measurement of the paper to be printed is to look for defects in the paper, such as holes and tears. Even with this method, no information can be obtained on the effect of variations in the quality of the printing paper on the printed area.

The print can also be monitored by taking samples of the printed paper and measuring them separately in a laboratory. However, this is time consuming and laborious. Moreover, if the measurement indicates variations in the print, the adjustment measures to improve the process will be taken too late to influence the print of the printing batch, of which the samples were taken. Furthermore, the error probability of the measurements will be increased, because the printed paper must be handled separately for the measurement.

### BRIEF DESCRIPTION OF THE INVENTION

The aim of the present invention is thus to provide a method for monitoring the quality of the print formed in a printing process, which eliminates the above-mentioned problems and by means of which it is possible to identify those elements of the printing process or process devices belonging to the printing process, whose condition or abnormal function cause variations in the print. It is also an aim of the invention to provide a method by means of which it is possible to identify quality variations of the paper to be printed in the machine direction. Furthermore, it is an aim of the invention to provide a device implementing the aforementioned method.

The invention is based on the idea of measuring an image pattern printed on a paper web and unprinted paper running continuously in the printing machine, or at least one runnability or condition monitoring of the printing machine, and factors affecting the quality of the print are determined on the basis of the measurements. The measurements are taken substantially continuously as the web runs through the printing process. The first measuring means used for measuring the paper web are placed in connection with the printing machine, in a suitable location in the printing process. A second measuring device for measuring at least one runnability or condition monitoring parameter of the printing machine is placed in connection with at least one moving or rotating part of the printing machine.

The paper web is measured at the location of one or more image patterns printed on the web to be measured particularly for the measurement. The image pattern is printed on the web during the printing process, simultaneously with the printing of the product to be printed, but separately from it. In this context, the product to be printed means a printed product ordered by a client, which may contain text and/or images and may be printed with one or more colours. The image patterns vary with respect to their size, colours and motifs according to the product to be printed and the measuring means used in the measurements. The image pattern is normally small in size; its width in the width direction of the paper may be, for example, 5 to 10 mm. Most commonly, the image patterns are fully covered coloured surfaces on which all the colour elements are used, namely black, cyan, magenta and yellow. If it is desired to measure the ink quantities applied in printing, the image pattern may contain bar elements printed with all the colour elements. With respect to the web to be printed, the image patterns are placed in margins to be cut off the final product so that they are not visible in the printed product. The image patterns may thus be placed not only in the margins of the web but also in the middle of the web in the width direction of the web, if the final product is cut so that the image patterns will remain in a part of the web to be cut off. The image patterns may be printed one after another in the same location on the area to be monitored in the length direction (MD-direction) of the web so that some unprinted clean paper will remain therebetween. Thus, the distances between the image patterns may vary. If desired, they can also be printed at regular intervals from each other. The image pattern may also be an elongated uniform print in the longitudinal direction of the web.

The first measuring devices for measuring the paper web are arranged to measure the web substantially continuously. During the measurement, the first measuring means measure both the image patterns printed on the web and the unprinted area between, before, after or next to them. The first measuring means are attached either directly to the process parts of the printing machine, or to a separate beam extending over the width of the web. The first measuring means can also be installed in a separate support, for example a stand, installed next to the edge of the web. The first measuring means measure the web printed with at least one colour. They can thus be placed at any location in the printing process after the first printing unit in the running direction of the web. Preferably, the first measuring means are placed after the drying section of the printing machine, before the folder unit.

The first measuring means are placed in the cross-direction of the web at either a continuous image pattern or a row of image patterns printed on the web and extending in the machine direction of the web. The measuring means can be installed in a stationary manner, or they may be movable in the width direction of the paper web. Particularly when the image pattern to be measured is an elongated image pattern in the machine direction of the web, it is advantageous that the measuring means can be moved in the width direction of the web at least to the other side of the image pattern and back, wherein the measurement of the unprinted paper can be made next to the image pattern. Furthermore, in the measurement of image patterns printed in the middle of the width of the web, it is advantageous that the measuring means can be transferred, when the web is moving, from its edge or from the outside of the edge to the measuring area. The measurements are thus made substantially at the image pattern or next to it, and they are not made in the whole cross-direction of the web. Thus, there may be one or more first measuring means, each measuring the image pattern or patterns extending or placed at the respective measuring means in the machine direction of the web.

The measurement sensors used for measuring the paper web are selected according to the property to be measured. They may be optical or radiometric sensors, or sensors based on camera technology. The most suitable properties to be measured for the monitoring of the quality of the print are the basis weight, R0, i.e. remission measurement, ash content, and transmission.

On the printing machine, at least one second measuring means is used for measuring parameters relating to the control of the condition and runnability of the printing machine, such as rotation frequencies or oscillations of the rolls of the printing machine. Measurement signals obtained from the measurements of the parameters relating to the image pattern and the unprinted paper or the condition monitoring and runnability of the printing machine are compared with each other, wherein variations in the quality of the print, caused by either the printing process or the paper, can be determined on the basis of the comparison. The processing and comparison of the measuring signals take place in a data processing unit. The invention suits particularly for determining periodic variations in the print, caused by components involved in the printing process.

The invention has the advantage that on the basis of the measurements, factors affecting the quality of the print can be recognized quickly when the printing is still going on in the printing machine. When both the image pattern and unprinted paper or parameters relating to the condition monitoring and runnability of the printing machine are measured and compared with each other, factors causing changes in the print can be differentiated and they can be identified as variations caused by either uneven properties of the paper to be printed or parts in the printing process. By means of the measurement results, the printing process can be adjusted during the printing in such a way that the print can be made as even as possible. Furthermore, better runnability of the printing machine will be achieved.

### BRIEF DESCRIPTION OF THE DRAWINGS

In the following, the invention will be described in more detail with reference to the appended drawings, in which

FIG. 1 shows, schematically seen from the side and in a partial cross-section, a printing machine with the device according to the invention integrated therein, and

FIG. 2 shows, seen from above, the printing machine of FIG. 1 between the lines B and C marked in the figure.

### DETAILED DESCRIPTION OF THE INVENTION

In this description, print refers to a location in the paper where a printed motif or text has been produced by a printing machine.

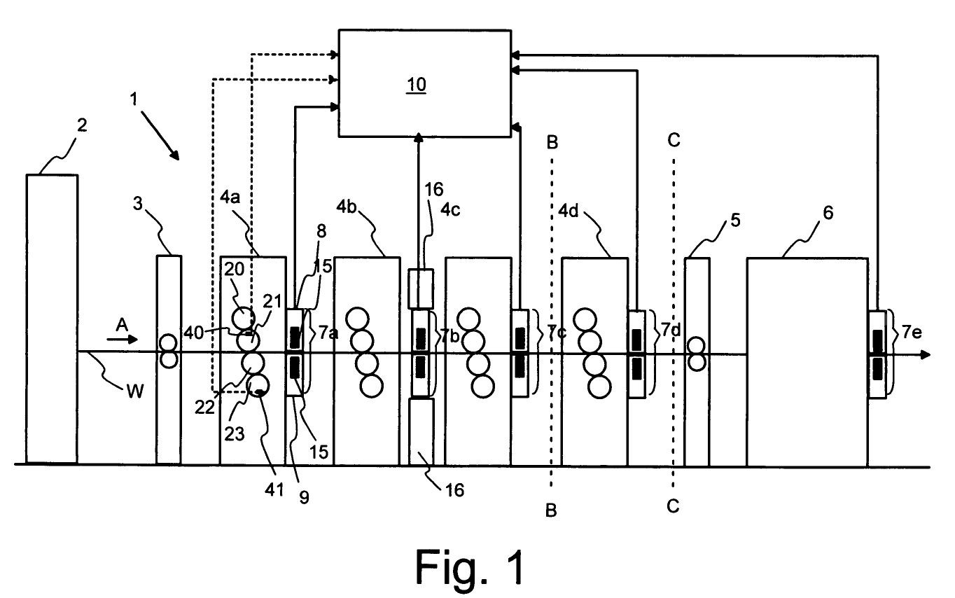

FIG. 1 shows schematically a printing machine 1 suitable for offset printing, for printing a web-like paper web W running substantially continuously in the direction of an arrow A. The paper web is introduced in rolls to an unwinder 2, from which the web is led forward into a web infeed unit 3 which feeds the web forward in the printing machine and simultaneously adjusts the tension of the web. From the feeding unit, the web enters the printing step, in which the web W is introduced through printing units 4a to 4d. In the printing units, the ink is transferred onto a printing plate, the printing plate is moistened, and the printing ink is transferred onto the printing roll, and the printing itself takes place, i.e. the printing ink is transferred from the printing roll onto the paper in a printing nip. The operation of the printing unit is known as such for a person skilled in the art, wherein it will not be described in more detail in this context. In the example of the figure, four printing units are shown, but their number may vary depending on the product to be printed and the printing machine. In each printing unit, one ink colour is printed on the web, and the colour shades of the final product are achieved by the combined effect of their printing on top of each other. Normally, the order of the ink colours used in the printing unit is the following: in the first unit 4a, the printing ink colour is black, in the second unit 4b cyan, in the third unit 4c magenta, and in the fourth unit 4d yellow. If desired, the printing order of the ink colours can also be changed. After the printing units, the web runs through a so-called web pick-up device 5 into the drying section 6, in which the web is dried before it is cooled down (not shown in the figure) and introduced into the folder unit (not shown in the figure). The function of the pick-up device is to prevent the accumulation of paper in the drying section in the case of a possible web break. In the drying section 6, the printed paper web is dried on both sides by means of hot air. The web runs through all the stages in the printing machine substantially without a support; that is, it is not supported by means of wires or felts.

According to the invention, simultaneously with the product to be printed, one or more image patterns are printed on the web, which are measured by one or more first measuring means 7a to 7e placed immediately after the printing units 4a to 4d or the drying section 6. The first measuring means can be fixed either to the printing unit 4a-4d, the drying section 6, or a beam installed after them in the cross direction of the web. In FIG. 1, as an example, the first measuring means 7b are placed in such a beam 16.

The first measuring means 7a-7e consist of at least one measuring head equipped with the measuring sensors. In the example of the figure, two measuring heads are provided and indicated with the numerals 8 and 9. The number of the measuring heads will depend on the web property to be measured and on the measuring technique used in the measuring. If a measurement through the web is used in the measuring, a radiation source and a detector to be used in the measurement are arranged in measuring heads arranged at the same location on opposite sides of the web. On the other hand, if the measurement is based on reflection measurement, the radiation source and the detector are arranged in the same measuring head. Thus, it will not be necessary to provide a second measuring head on the opposite side of the measuring point.

The measuring heads 8 and 9 are placed in the vicinity of the web in such a way that the windows in them, which isolate the measuring sensors 15 from the outer environment, are as close to the surface of the moving web as possible but do not touch it. There is thus a small air gap between the web and the window.

The measuring sensors 15 and the parts belonging to them are provided inside the measuring heads 8 and 9. It is possible to provide the same measuring head with one or more measuring sensors 15 for measuring the properties of the web, wherein it is possible to measure one or more properties of the same image pattern printed on the web and, correspondingly, of the unprinted paper around the same.

One or more of the following properties of the printed web, i.e. the image pattern and the unprinted web, are measured: basis weight, R0, i.e. remission, and transmission. Thus, the first measuring means comprise the measuring sensors and other components needed for measuring at least one of the above-mentioned properties. Preferably, the measurement is taken as a remission measurement.

Basis weight measurement is generally considered to be only a property of unprinted paper. However, it is possible to measure the basis weight of printed paper, wherein the printing ink produces an increase in the basis weight, which can be noticed in the measurement. The basis weight is measured by through-measurement principle, wherein a radiation source based on beta emission and a detector are provided on one and the other side of the paper to be measured, respectively. The basis weight sensor is used for measuring basis weight values of the image pattern.

An R0 sensor or remission sensor is used for measuring the tone value or density of the printed image pattern. The density measurement is made as a reflection measurement, wherein a radiation source is provided on one side of the paper to illuminate the object to be measured with white light at an angle of 45 degrees. A detector is provided on the same side of paper to measure the light reflected from the paper at an angle of 90 degrees.

The transmission measurement is used for measuring the permeability of light through the printed image pattern. The transmission measurement is made by the principle of through-measurement, wherein a radiation source emitting visible light and a detector are provided on one and the other side of the paper to be measured, respectively.

In the measurements by the above-described first measuring means, measurement results are collected from the printed image pattern. If variations are detected in them, more measurements will be needed to find out the reasons for the variations. In the printing process, variations in the printed product may be caused by either the paper to be printed or the printing machine itself. To find out the variations caused by paper, unprinted paper around the image patterns is measured according to the invention. On the other hand, to find out variations caused by parts of the printing machine, oscillations of the parts of the printing machine are measured according to the invention, such as the oscillation frequencies of the rolls or the rotation frequencies of the rolls. These measurements may be called runnability or condition monitoring parameters of the printing machine.

By comparing the measurement results obtained from the measurements of the image pattern and the unprinted paper or the runnability or condition monitoring parameters of the printing machine, it is possible to determine the cause of the variations in the image pattern. The measurements of unprinted paper are used to find out deviations in the machine direction which are visible in the image pattern and the print. From the oscillation measurements of the rolls of the printing machine, possible deviations caused by oscillations of the rolls are determined, which cause changes in the image pattern and also in the print. From the measurements of the rotation frequency of the rolls, periodic changes in the image pattern and the print caused by the rotation of the rolls are determined.

The placement of the second measuring means, that is the means for measuring the runnability or condition monitoring parameters of the printing machine, in the printing machine is shown as an example in FIG. 1. The second measuring means are, for example, vibration transducers and/or sensors measuring the rotation frequency. A vibration transducer 40 is placed at the end of a roll 21 belonging to the printing unit 4a, to measure vibrations of the rotating roll. A sensor 41 measuring the rotation frequency is placed in the roll 23 of the printing unit 4a. The signals obtained from the vibration transducer 40 and the rotation frequency sensor 41 are led into a data processing unit 10. The number of vibration transducers 40 and rotation frequency sensors 41 may naturally vary in the printing machine. The printing machine may comprise solely vibration transducers or rotation frequency sensors. Furthermore, the sensors may be placed in any roll belonging to the printing machine 1. The function of the vibration transducers and the rotation sensors is known for a person skilled in the art, wherein it will not be described in more detail in this context.

The measuring results obtained by the measuring means 7a-7e are also led into the data processing unit 10, in which the signals obtained from the measurements are processed. In the data processing unit, the measurement results obtained from the image patterns and the unprinted paper or the runnability or condition monitoring parameters of the printing machine are compared and the factors affecting the quality of the print are determined. As a result from the processing, information about the condition and function of the parts of the printing unit as well as about variations in the quality of the paper is obtained. By means of measurements on the vibration and rotation frequency of the rolls, it is possible, for example, to specify a given printing unit or a single roll of the printing machine that causes variations in the quality of the paper. Thus, for example, in connection with the next downtime of the printing machine it is possible to change and overhaul those parts of the printing machine which were found to cause variations in the quality of the print.

Naturally, the first measuring means can also be used to measure other factors affecting the quality of the printed product. For example, the measurement of the basis weight of the image patterns can be used to monitor variations in the quantity of the printing ink and thereby also in the printed surface, and remission measurement can be used to monitor variations in the print.

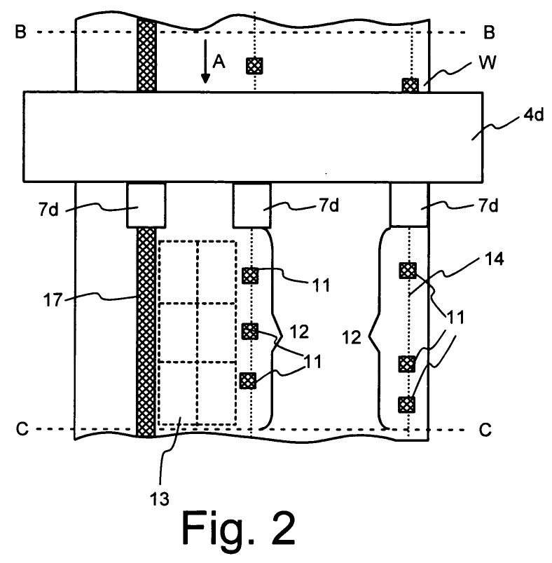

FIG. 2 shows, seen from above, the printing machine of FIG. 1 between the lines B and C marked in FIG. 1. The web W runs in the direction of the arrow A through the printing unit 4d. The frame of the printing unit 4d, after the printing unit in the running direction of the web, three first measuring means 7d are fixed for measuring the web. The measuring sensors in the measuring means measure the image patterns 11 printed on the web which have been printed on the web on the same line in the machine direction of the web at regular intervals 14 so that they form image pattern rows 12. One of the measuring sensors 7d measures an elongated solid image pattern 17. The image patterns 11 and 17 are printed on the web so that they are not visible in the product 13 to be printed but remain in the margins to be cut off during the finishing of the web.

In the example of FIG. 2, there are three first measuring means 7d in the width direction of the web. The number and location of the measuring means in the width direction of the web may vary according to the desired measuring density in the cross direction of the web. It is essential that one image pattern or image pattern row is printed on the web in the measuring range of each first measuring means. The measuring means fixed in the width direction of the web may all comprise measuring sensors measuring the same property/properties of the web, or the measuring means may comprise measuring sensors measuring different properties of the web. Each of the first measuring means 7d may comprise one measuring sensor or several measuring sensors for measuring different properties of the image pattern and unprinted paper. The measuring means 7d may also move in the direction of the frame of the printing unit 4d, wherein they measure the unprinted paper next to the image pattern.

The invention is not intended to be limited to the embodiments presented as examples above, but the invention is intended to be applied widely within the scope of the inventive idea as defined in the appended claims. The invention may thus be applied for monitoring the quality of print of printed products produced by also other printing methods, such as the gravure printing method.

1. A method for monitoring the quality of print formed in a printing process, wherein both a printed product and at least one image pattern is printed on a paper web running continuously in a printing machine, which image pattern is separate from the printed product and whose surroundings comprises unprinted paper, and in which method the image pattern is measured after the printing substantially continuously by at least one measuring means, wherein the method comprises the following steps:
measuring in addition to the printed image pattern also the unprinted paper by the same measuring means, or at least one runnability or condition monitoring parameter of the printing machine,
comparing the measurement results obtained from the measurement of the image pattern and the unprinted paper or the runnability or condition monitoring parameter of the printing machine, and
determining at least one factor affecting the quality of the print on the basis of the comparison.

2. The method according to claim 1, wherein the measuring step comprises measuring several image patterns printed at a distance from each other, one after the other, in the longitudinal direction of the paper web.

3. The method according to claim 2, wherein the measuring step comprises measuring the unprinted paper remaining between or next to the image patterns.

4. The method according to claim 1, wherein the measuring step comprises measuring an image pattern which is one of the following: a fully covered colour surface printed with one colour, a fully covered colour surface printed with several colours, or a bar element printed with several colours.

5. The method according to claim 1, wherein the measuring step comprises measuring the image pattern and the unprinted paper by at least one measuring means installed substantially in a stationary manner in the width direction of the paper web (W).

6. The method according to claim 1, wherein the image pattern and the unprinted paper are measured optically or radiometrically.

7. The method according to claim 1, wherein the measuring step comprises measuring at least one of the following properties of the printed image pattern and the unprinted paper: basis weight, R0, i.e. remission, or transmission.

8. The method according to claim 1, wherein the measuring step comprises measuring at least one property of the image pattern and the unprinted paper by a first measuring means with one or more measuring sensors for measuring one or more properties.

9. The method according to claim 1, wherein the measuring step comprises measuring vibrations or the rotation speed of the rolls of the printing machine by at least one second measuring means.

10. The method according to claim 1, wherein the determining step comprises determining the periodicity of the vibrations or the rotation speed of the unprinted paper and the rolls of the printing machine from the measurement results of the first and the second measuring means.

11. The method according to claim 1, wherein the image pattern to be measured is printed substantially simultaneously with the printing of the product to be printed on the paper web.

12. The method according to claim 1, wherein the determining step comprises determining at least one of the following factors affecting the quality of the print from the measurement results: variations in the quality of the paper web in the machine direction, or variations in the quality caused by the rolls of the printing machine.

13. A device for monitoring the quality of print formed in a printing process, which device comprises
a printing machine for printing on a paper web running continuously in the printing machine a product (13) to printed, and at least one image pattern separately from the product to be printed, having unprinted paper around the image pattern,
at least one first measuring means arranged to measure the image pattern substantially continuously, and
a data processing unit for processing the measurement results obtained by the first measuring means,
wherein the device also comprises at least one second measuring means for measuring runnability or condition monitoring parameters of the printing machine, and that the device is arranged
to measure in addition to the printed image pattern also the unprinted paper by the same first measuring means, or at least one runnability or condition monitoring parameter of the printing machine by the second measuring means,
to compare the measurement results obtained from the measurement of the image pattern and the unprinted paper or the runnability or condition monitoring parameter of the printing machine, and
to determine at least one factor affecting the quality of the print on the basis of the comparison.

14. The device according to claim 13, wherein the device is arranged to measure several image patterns printed at a distance from each other, one after the other, in the longitudinal direction of the paper web.

15. The device according to claim 14, wherein the device is arranged to measure the unprinted paper remaining between or next to the image patterns.

16. The device according to claim 13, wherein the image pattern is one of the following: a fully covered colour surface printed with one colour, a fully covered colour surface printed with several colours, or a bar element printed with several colours.

17. The device according to claim 13, wherein the first measuring means is installed in a substantially stationary manner in the width direction of the paper web and that it is fixed to one of the following: a printing unit, a drying section, or a beam extending over the width of the paper web.

18. The device according to claim 13, wherein the first measuring means is installed in a substantially stationary manner in a support arranged outside the edge of the paper web.

19. The device according to claim 13, wherein the first measuring means comprises one or more measuring sensors for measuring one or more properties.

20. The device according to claim 17, wherein the first measuring means comprises at least one measuring head arranged close to the surface of the web and provided with one or more measuring sensors.

21. The device according to claim 20, wherein the first measuring means comprises two measuring heads arranged substantially at the same location on both sides of the web.

22. The device according to claim 17, wherein the measuring sensor measures the printed image pattern and the unprinted paper optically or radiometrically.

23. The device according to claim 13, wherein the device is arranged to measure at least one of the following properties: basis weight, R0, i.e. remission, and transmission.

24. The device according to claim 13, wherein the second measuring means is a vibration transducer or a sensor measuring the rotation speed of a roll.

25. The device according to claim 13, wherein the device is arranged to determine the periodicity of the vibrations or the rotation speed of the unprinted paper and the rolls of the printing machine from the measurement results of the first and the second measuring means.

26. The device according to claim 13, wherein the image pattern has been printed on the paper web substantially simultaneously with the printing of the product to be printed.

27. The method according to claim 13, wherein the device is arranged to determine from the measurement results at least one of the following factors affecting the quality of the print: variations in the quality of the paper web in the machine direction, or variations in the quality caused by the rolls of the printing machine.
